(19) United States
(12) Patent Application Publication
(10) Pub. No.: US 2022/0159016 A1
(43) Pub. Date: May 19, 2022

(54) NETWORK DATA TRAFFIC IDENTIFICATION

(71) Applicant: Red Piranha Limited, Perth, Western Australia (AU)

(72) Inventors: Adam BENNETT, Perth, Western Australia (AU); Siarhei FILIPOVICH, Minsk (BY)

(73) Assignee: Red Piranha Limited, Perth, Western Australia (AU)

(21) Appl. No.: 17/436,630

(22) PCT Filed: Mar. 5, 2020
(86) PCT No.: PCT/AU2020/050208

§ 371 Date: Sep. 6, 2021

(30) Foreign Application Priority Data
Mar. 5, 2019 (AU) 2019900717

(51) Int. Cl. H04L 9/40

(52) U.S. Cl. CPC H04L 63/1416; H04L 63/1425; H04L 63/166; H04L 63/0245; H04L 63/145

(57) ABSTRACT

A method and system for permitting data traffic over a network comprises receiving a transport layer security handshake data packet from a client over a network; extracting data from the packet; hashing/fingerprinting the extracted data; comparing the hashed data to a list of hashes of applications that are authorised and/or not authorised on the network. In one embodiment the list is determined according to an identity of the client.

### FIELD OF THE INVENTION

The present invention relates to identification of data traffic on a computer network. In particular, the identification is able to be used for computer network security.

### BACKGROUND

Computer networks carry data between devices connected via the network. It is typical now for a local area network to be connected to a wide area network, such as the Internet. It is also typical for a device connected to the network to access software services via the Internet.

Individual devices can be infected by malicious software (malware), such as computer viruses. The malware can cause the device it has infected to access a service via the Internet, or to send data to a destination on the Internet. Further, businesses may also wish to impose limitations on use of the network infrastructure for network traffic that is work related or otherwise permitted, even if the traffic is not generated by malware.

Intrusion detection systems (IDS) are designed to monitor the local part of the network for malicious activity or activity that is a violation of policy on the use of the network. Typically, the IDS looks for a signature of malware and/or looks for anomalous behaviour. An IDS that can respond to a detected intrusion may be referred to as an intrusion prevention system (IPS).

However, the signature of malware can be difficult to detect, particularly if it is encrypted. Indeed, the signature of authorised communication is also typically encrypted such that typically an IDS that seeks to detect the signature of malware inside an encrypted data packet may not be practicably distinguishable from the signature of authorised software inside an encrypted data packet. Thus, signature detection typically focuses on unencrypted data inside of a host or client device before it is encrypted, rather than on the network after it is encrypted.

Transport Layer Security (TLS) (or its predecessor Secure Socket Layer (SSL)) handshake data packet fingerprinting has been used to identify a data packet from known client (by knowing a certain characterising fingerprint) seeking to enter a database system, as is described in US20180324153. Data packets from known, permitted clients with known TLS fingerprints can be whitelisted and permitted access to the database system. Data packets from known, prohibited clients with known TLS fingerprints can be blacklisted and denied access to the database system. This is an endpoint access control mechanism of incoming data traffic to the endpoint database system.

The present invention seeks to identify authorised use of the network so as to control use of the network (as opposed to permitting or denying access to a database system, which is an endpoint node of a computer network).

Notably a device may be permitted to use a software application outside of the local network, may be not be permitted to use the software application to communicate using the local network. The present invention seeks to allow this policy control to be put into effect within the network infrastructure.

### SUMMARY OF THE INVENTION

According to an aspect of the invention there is provided a method of forming a list of software applications authorised to use a computer network, comprising:

receiving at least two transport layer security handshake data packets sent over a computer network from a known software application running on a client device within the network;
extracting data from the received packets;
producing a fingerprint of the extracted data for each of the received packets, wherein the fingerprint for each packet identifies the known software application and the fingerprints from respective packets are not identical;
storing each non-identical fingerprint in a relationship with an identifier of the known software application;
storing an indication of whether each known software application is an authorised software application for the client device and/or is an authorised software application for the computer network.

In an embodiment the non-identical fingerprints of the known software application are stored in a many to one relationship. That is, two or more unique fingerprints identify the one known software application.

In an embodiment the method further comprises storing an indication of whether each client device is authorised to use each known software application over the computer network.

In an embodiment producing the fingerprint comprises hashing the extracted data. In an embodiment the hashing used is the MD5 hash algorithm.

In an embodiment the extracted data comprises at least 2 data elements, preferably 3 data elements, more preferably 4 data elements and most preferably 5 or more data elements from the packet.

In an embodiment the data elements describe details of the secure connection that is to be negotiated by the handshake.

In an embodiment the data elements comprise a data element that defines the version of transport layer security supported by the client. In an embodiment the data elements comprise a data element that defines the cipher suites supported by the client. In an embodiment the data elements comprise a data element that defines the length of extensions to the transport layer security protocol supported by the client. In an embodiment the data elements comprise a data element that defines the type of public key cryptography algorithm supported by the client. In an embodiment the type of public key cryptography algorithm Is a type of elliptic curve algorithm. In an embodiment the data elements comprise a data element that defines a parameter of the public key cryptography algorithm. In an embodiment the parameter is an elliptic curve point format.

Also according to the present invention, there is provided a method of permitting data traffic over a network, comprising:

receiving a transport layer security handshake data packet sent over a computer network from a software application running on a client device from within the computer network;
extracting data from the packet;
producing a fingerprint of the extracted data;
comparing the fingerprint to a whitelist library of fingerprints of authorised software applications so as to identify whether the fingerprint is in the whitelist library;
in the event that the fingerprint is in the whitelist library, permitting outgoing data traffic from the client over the network and/or outgoing data traffic from the client to a connected external network.

In an embodiment the method further comprises, in the event that the fingerprint is not in the whitelist library, denying data traffic from the client over the network and/or to the connected external network. Further, in the event that the fingerprint is not in the whitelist library, generating an alert.

In an embodiment the method further comprises comparing the fingerprint to a blacklist library of fingerprints of unauthorised software applications so as to identify whether the fingerprint is in the blacklist library; wherein in the event that the fingerprint is in the blacklist library dropping the data packet; wherein in the event that the fingerprint is not in the whitelist library or the blacklist library, then the method further comprises triggering further investigation of the software application.

In an embodiment the method further comprises determining whether the client device is permitted to use the software application on the network according to the identified fingerprint and in the event that the device is permitted to use the software application on the network allowing the handshake data packet to be transmitted over the network.

In an embodiment a rule or rule set is applied to the fingerprint to determine an extent of permission of data traffic from the client to the network.

In an embodiment the fingerprint is sent from a sniffing device on the network to a remote service for comparing to the whitelist, and an indication as to whether the software application is on the whitelist is returned from the remote service to the sniffing device.

In an embodiment the permitting or denying of data traffic is performed by an intrusion security device on the network. In an embodiment the indication as to whether the software application is on the whitelist is provided to the intrusion security device.

Also according to the present invention there is provided a method of permitting data traffic over a network, comprising

receiving a transport layer security handshake data packet from a client over a network; extracting data from the packet;
hashing the extracted data;
comparing the hashed data to a list of hashes of applications that are not authorised on the network.

An embodiment further comprises disallowing the handshake data packet to be transmitted over the network in the event that the hashed data is on the list of hashes of applications that are not authorised on the network.

In an embodiment the method further comprises comparing the hashed data to a list of hashes of applications that are authorised on the network. An embodiment further comprises disallowing the handshake data packet to be transmitted over the network in the event that the hashed data is not on the list of hashes of applications that are authorised on the network.

In an embodiment the list of hashes is determined according to the identity of the client.

Also according to the present invention there is provided a method of permitting data traffic over a network, comprising

receiving a transport layer security handshake data packet from a client over a network; extracting data from the packet;
hashing the extracted data;
comparing the hashed data to a list of hashes of applications that are authorised on the network.

An embodiment further comprises disallowing the handshake data packet to be transmitted over the network in the event that the hashed data is not on the list of hashes of applications that are authorised on the network.

In an embodiment the list of hashes is determined according to the identity of the client.

According to another aspect of the invention there is provided a device for forming a list of software applications authorised to use a computer network, comprising:

a network connection for receiving a transport layer security handshake data packets sent over a computer network from a known software application running on a client device within the network;
a processor for extracting data from the received packet and producing a fingerprint of the extracted data for each of the received packets, wherein the fingerprint for each packet identifies the known software application and the fingerprints from respective packets may not be identical;
a data store for storing each non-identical fingerprint in a relationship with an identifier of the known software application;
a data store for storing an indication of whether each known software application is an authorised software application for the client device and/or is an authorised software application for the computer network.

In an embodiment the data store is further configured to store an indication of whether each client device is authorised to use each known software application over the computer network.

Also according to the present invention, there is provided a device for permitting data traffic over a network, comprising:

a network connection for receiving a transport layer security handshake data packet sent over a computer network from a software application running on a client device within the network;
a processor for extracting data from the received packet and producing a fingerprint of the extracted data;
a processor for comparing the fingerprint to a whitelist library of fingerprints of authorised software applications so as to identify whether the fingerprint is in the whitelist library;
an output for signalling data traffic from the client over the network is permitted in the event that the fingerprint is in the whitelist library.

In an embodiment the signalled data traffic permitted is the transport layer security handshake data packet or data traffic related to transport layer security handshake data packet.

In an embodiment the data traffic related to transport layer security handshake data packet is traffic directed to a network connected service having a destination address included in the extracted data.

In an embodiment the output is further configured to signal data traffic related to the software application is not permitted in the event that the fingerprint is not in the whitelist library.

In an embodiment the processor is configured to compare the whitelist library according to the identity of the client device.

Also according to the present invention, there is provided a device for permitting data traffic over a network, comprising:

a network connection for receiving a transport layer security handshake data packet from a client over a network;
a processor for extracting data from the packet; and for hashing the extracted data; and for comparing the hashed data to a list of hashes of applications that are either or both: authorised or not authorised on the network.

Also according to the present invention, there is provided a device for permitting data traffic over a network, comprising:

a network connection for receiving hashed data extracted from a transport layer security handshake data packet from a client over a network;
a processor for comparing the hashed data to a list of hashes of applications that are either or both: authorised or not authorised on the network;
an output for transmitting the result of the comparison.

Also according to the present invention, there is provided a method for permitting data traffic over a network, comprising:

receiving hashed data extracted from a transport layer security handshake data packet from a client over a network;
comparing the hashed data to a list of hashes of applications that are either or both: authorised or not authorised on the network;
transmitting the result of the comparison.

In an embodiment the transmitted result is returned to the source of the received hashed data. In an embodiment the source is identified by the identity of the client. In an embodiment the list of hashes is determined according to the identity of the client.

Also according to the present invention, there is provided a method for permitting data traffic over a network from a particular device, comprising:

identifying the device on the network;
receiving hashed data extracted from a transport layer security handshake data packet from a client software application running on the identified device which has been sent over from the identified device over the network;
extracting data from the received data packet;
hashing the extracted data to form a fingerprint;
comparing the fingerprint to a list of fingerprints of applications that are authorised on the network for the identified device;
based on the result of the comparison, either permitting or denying traffic related to the application from the identified device over the network.

Also according to another aspect of the present invention there is provided a computer program product stored in a computer readable medium comprising instructions for controlling a processor to perform one or more of the above defined methods.

In this specification the terms “comprising” or “comprises” are used inclusively and not exclusively or exhaustively.

Any references to documents that are made in this specification are not intended to be an admission that the information contained in those documents form part of the common general knowledge known to a person skilled in the field of the invention, unless explicitly stated as such.

### SUMMARY OF THE FIGURES

In order to provide a better understanding of the present invention, example embodiments are described with reference to the accompanying Figures, in which:

FIG. 1 is a block diagram schematically showing a computer network architecture;

FIG. 2 is a schematic flow chart showing a process of allowing network data according to an embodiment of the present invention;

FIG. 3 is a schematic flow chart showing an alternative portion of the process of

FIG. 2 according to another embodiment of the present invention;

FIG. 4 is a schematic flow chart showing another alternative portion of the process of FIG. 2 according to another embodiment of the present invention;

FIG. 5 is a schematic block diagram of an Intrusion Detection System or an Intrusion Prevention System according to an embodiment of the present invention;

FIG. 6 is a screenshot of a listing of extracted information and a fingerprint of a transport layer security message according to an embodiment of the process of FIG. 2;

FIG. 7 is shown a flow diagram of use of example tools according to an embodiment of the present invention;

FIG. 8 is a screenshot of a user interface showing a map of devices on a local network;

FIG. 9 is a screenshot of a user interface showing options available in relation to a selected device on the local network;

FIG. 10 is a screenshot of a user interface showing selection of a security policy to be applied to a device on the local network;

FIG. 11 is a screenshot of a user interface showing a map of devices on a local network from which software application fingerprints have been collected;

FIG. 12 is a screenshot of a user interface showing options available in relation to an identified software application fingerprints;

FIG. 13 is a screenshot of a user interface showing fingerprints of software applications obtained from a selected device on the local network; and

FIG. 14 is a screenshot of a user interface showing a listing of rules applied to fingerprints of network traffic from a device;

FIG. 15 is screenshot of a user interface showing a rule group manager;

FIG. 16 screenshot of a user interface showing the allocation of different policies to each group.

### DETAILED DESCRIPTION OF EMBODIMENTS OF THE INVENTION

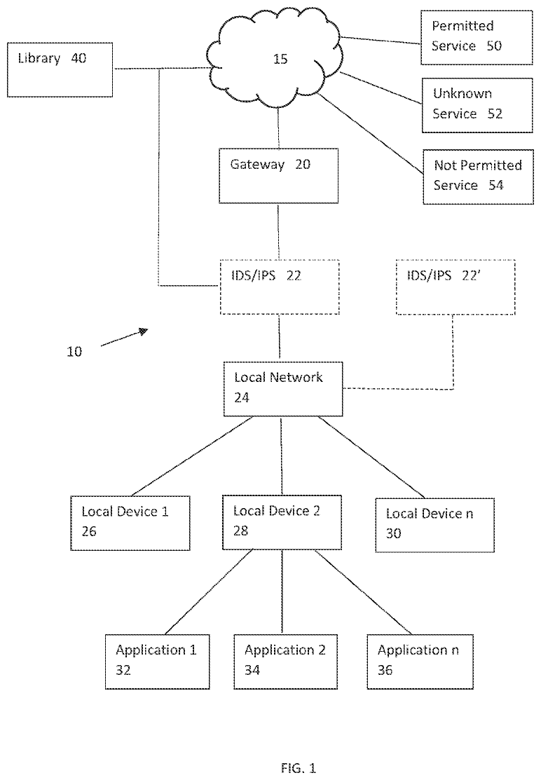

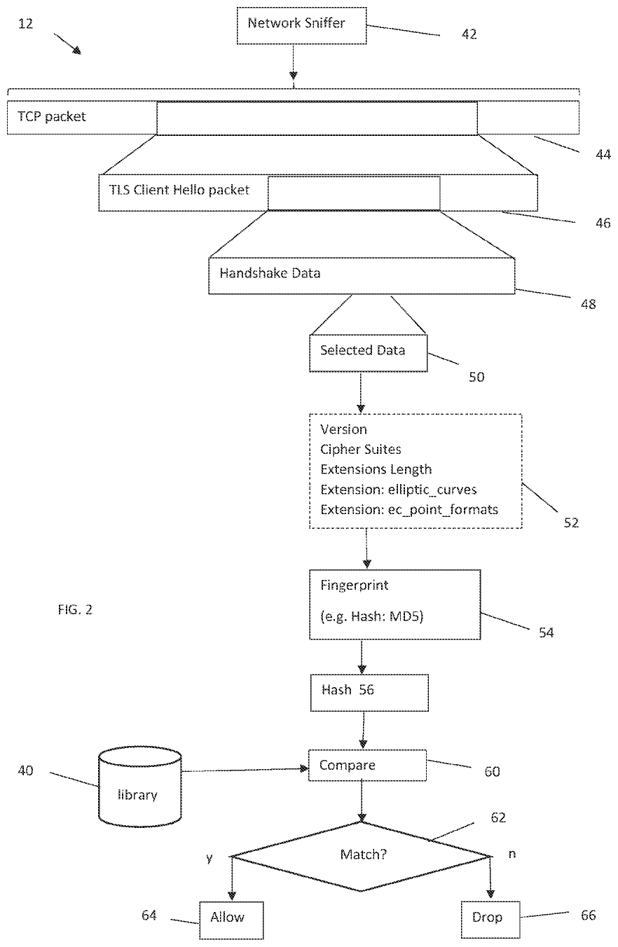

Referring to FIG. 1, there is shown a computer network architecture 10 according to an embodiment of the present invention. The network 10 comprises a local area network (LAN) 24, such as an ethernet network or WiFi network, or combination. The LAN 24 may comprise, switches, access points, bridges etc. Connected to the LAN 24 are one or more local devices, such as local device 1 26, local device 2 28 and up to n local devices 30. These devices 26, 28, 30 may be for example, personal computers, portable computers, tablet computers, smart phones, peripheral devices, such as printers etc. Each of devices 26, 28, 30 may run a software application that may require access to an online service.

The LAN 24 is connected, via a gateway 20, to a wide area network, which may be the Internet 15. The gateway 20 may be a part of a router connecting the LAN 24 to the Internet 15.

Depending on the configuration desired, an intrusion detection system (IDS) and/or an intrusion prevention system (IPS) may be interposed between the LAN 24 and the gateway 20 as indicated by 22, or the IDS/IPS may comprise a device connected to the LAN 24, without interposing between the LAN 24 and the gateway 20, as indicated by 22′. The IDS/IPS 22, 22′ may comprise a mechanism for blocking traffic provided to the gateway 20. Alternatively, the IDS/IPS 22/22′ may control a firewall of a router or other equipment comprising the gateway 20 so as to block traffic passing through the gateway 20. The IDS/IPS 22, 22′ may form part of the gateway 20.

Elsewhere and accessed via the Internet 15 are the online services operated by external computers. Some of these services are permitted 50 to be accessed by the devices 26, 28, 30, for example an on-line email service or a productivity aiding website. Some of these services are not permitted 54 to be accessed by the devices 26, 28, 30, possibly because they are known malicious services (such as for example a keyboard logger destination), or are not permitted for policy reasons (an enterprise disapproved social media site). Some of these services are unknown 52 and potentially may be permitted 50 to be accessed by the devices 26, 28, 30 once they become known and approved of, but generally unknown services are new and not yet categorized as permitted or not permitted.

The network 10 also may comprise a library 40, which is a repository of fingerprints of known software applications that access the online services 50, 52, 54. The library may be inside of the LAN 24, or may be an online services accessed via the Internet 15.

The IDS/IPS 22/22′ is configured (for example as a sniffer device) to inspect network data packets destined for the online services 50, 52, 54 and is also configured to decide whether to allow or block (cause to be dropped) the data packets based on a fingerprint determined from particular data packets, and in particular in this embodiment transport layer security handshake data packets.

FIG. 2 shows a process 12 of packet inspection and decision making on whether to allow or drop the packet. The IDS/IPS 22/22′ comprises a network packet sniffer 42, which is able to inspect packets within the LAN 24 and which are destined for the Internet 15 (and in particular destined for the services 50, 52, 54). Typically, the transport layer security handshake data packets are a part of the payload of a TCP packet 44. Each TCP packet 44 can be inspected by the sniffer 42 to identify its destination, as indicated for example by its destination IP address. Those which have an IP address accessed via the Internet 15 can be inspected further, although it is also possible to inspect further TCP packets which have an IP address destination within the LAN 24.

Each TCP packet can be inspected to determine whether it has a transport layer security (TLS) protocol handshake data packet 46 in its payload. TLS is a session protocol implemented between an application of a client and a host and is used to establish a secure communication channel over a transport layer of a data connection. TLS 1.0 is defined by RFC 2246, TLS 1.1 is defined by RFC 4346, TLS1.2 is defined by RFC 5246 and TLS 1.3 is defined by RFC 8446, all by the Internet Engineering Task Force. It is noted that in the present invention reference to TLS is intended to cover backward compatibility, including secure socket layer (SSL) packets. SSL 3.0 became known as TLS 1.0.

A TLS handshake data packet 46 is also known as a Client Hello packet as it is the first of a set of handshaking exchanges between a client (one of the devices 26, 28, 30) and a host (operating one of the online services 50, 52, 54) so as to establish a secure, encrypted communication channel between the client and the host. The Client Hello packet must be transmitted “in the clear” (unencrypted), as a result its contents can be inspected without requiring decryption. In particular, the handshake data 48 of the TLS handshake data packet 46 is extracted.

The handshake data 48 will typically include a random string used to create the secure communication channel. However, for the application of this invention, this is unwanted. Only selected data 50 is wanted, which is extracted.

An example of the contents of a handshake data packet is below:

In an embodiment the selected data comprises at least 2 data elements, preferably 3 data elements, more preferably 4 data elements and most preferably 5 or more data elements from the packet. In this embodiment the selected data is indicated as 52, and is Version; Cipher Suites; Extensions Length; Extension: elliptic_curves; and Extension: ec_point_formats. These are indicated with arrows in the example handshake data packet above.

A fingerprint 54 is computed from the selected data 52 preferably using a hash of the selected data. Preferably the hash is an MD5 hash, which is a 128-bit message digest of the selected data 52. The MD5 hash function is well known to those skilled in the field of this invention and is for example described in the Wikipedia article at ‘https://en.wikipedia.org/wiki/MD5’.

The resulting digest (aka the hash 56 of the selected data 52) is unique to, or at least distinctive enough of, the software application of the source device 32, 34, 36 that generated the TLS Client Hello packet 46 so as to serve as a fingerprint of the software application. This in turn allows the software application to be determined by determining the fingerprint, with at least a high degree of certainty.

This can be implemented on the devices 32, 34, 36. For example, data packet fingerprinted can done on a database system implementing one or more services 50, 52, 54 to determine whether an incoming data packets is to be permitted or denied. However is was unexpectedly realized that contrary to current expectations to perform this inside of a host or client device 32, 34, 36, instead fingerprint or signature detection is done on the network in the present invention by being implemented (or possibly implemented additionally) by the IDS/IPS 22/22′ on outgoing data packets. This is because it is a different paradigm to screen outgoing traffic, where different organisations set different policies of what is permitted to be used on outgoing traffic as opposed to incoming traffic. That is not to say that screening of incoming traffic should not occur, or could not occur in combination with the present invention, but rather that the objective of outgoing screening is different to the objective of incoming screening and so screening of incoming traffic is not a prediction of the benefit or how to screen outgoing traffic.

Furthermore, incoming screening is done in an environment of preventing unwanted incoming traffic, where what is unwanted is essentially static. Whereas the source of outgoing can be dynamic in terms of the applications producing traffic and the devices connected to the network.

The library 40 comprises fingerprints of known software applications (and in this embodiment known software applications that are permitted to access the permitted services 50, herein referred to as a whitelist). The IDS/IPS 22/22′ compares (or causes to be compared) the whitelist with the hash 56 at 60. If the comparison is a match (‘y’ branch of comparison 62) then the packet 44 is allowed 64 to proceed. However, in this embodiment, if the comparison is not a match (‘n’ branch of comparison 62) then the packet 44 is not allowed to proceed, typically by the packet simply being dropped 66 or blocked from passing through a firewall of the gateway 20 to the service 50, 52, 54 over the Internet 15.

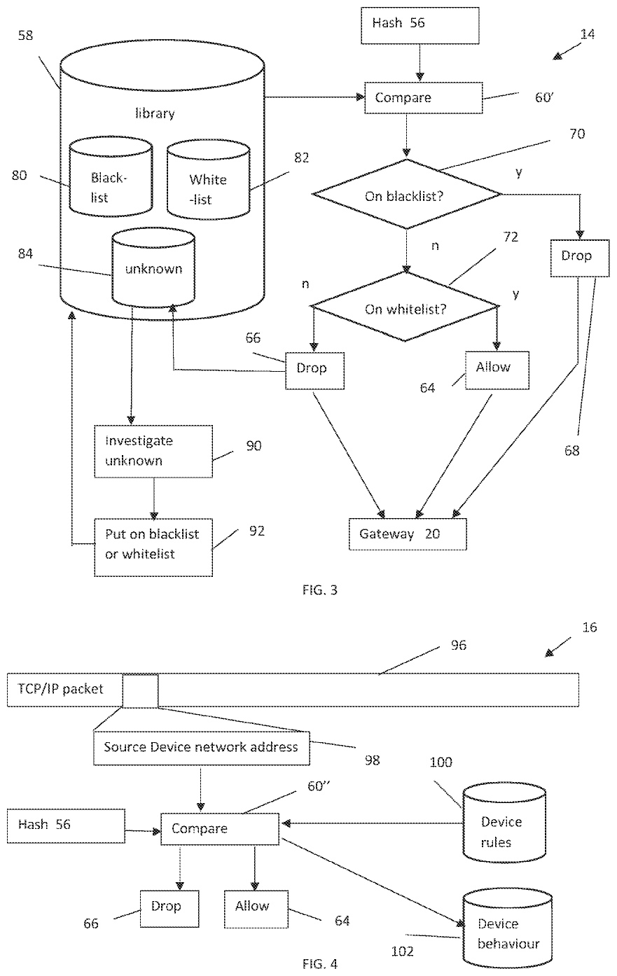

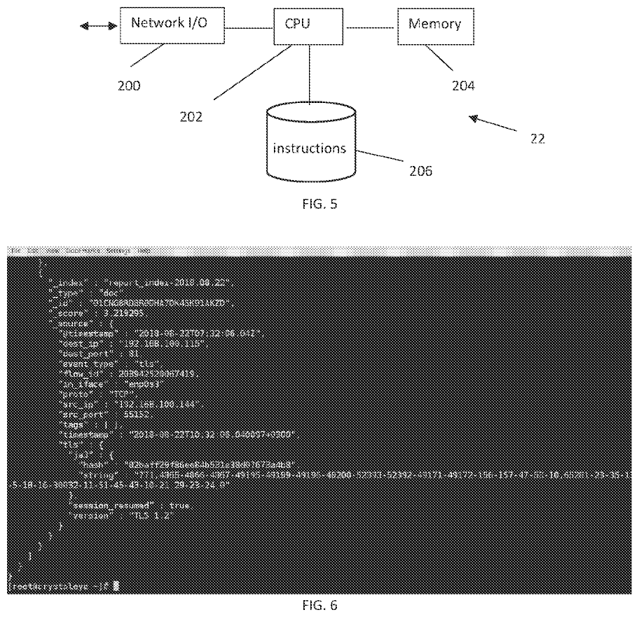

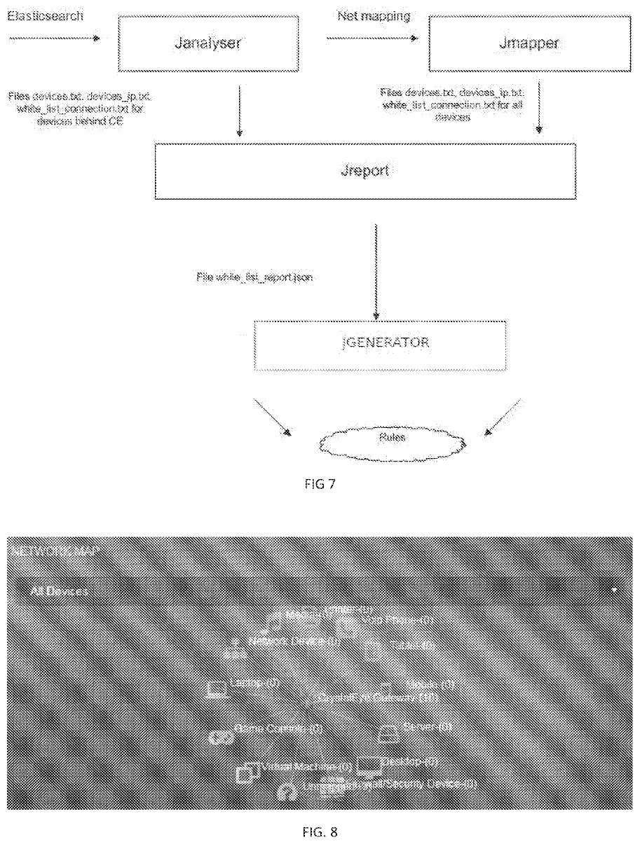

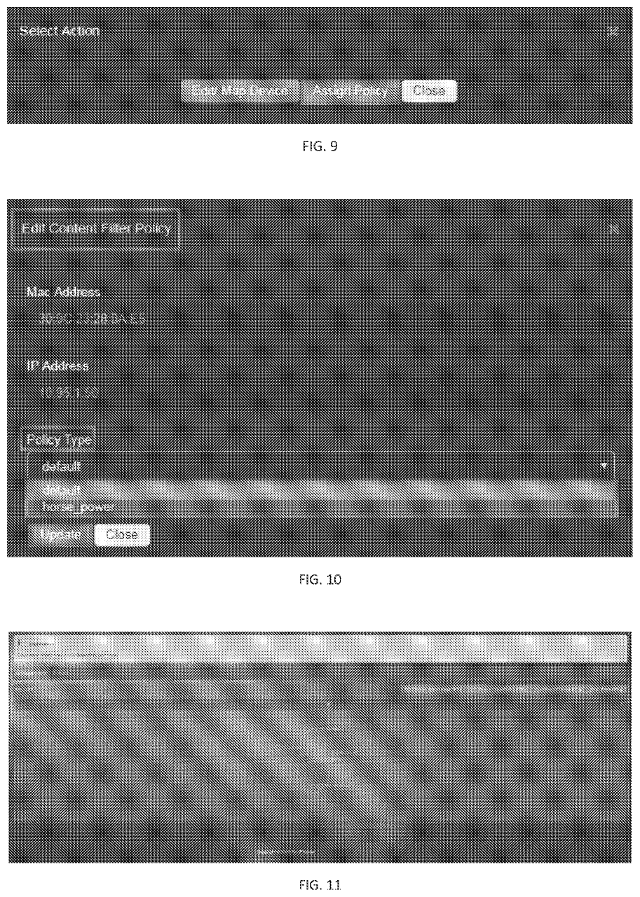

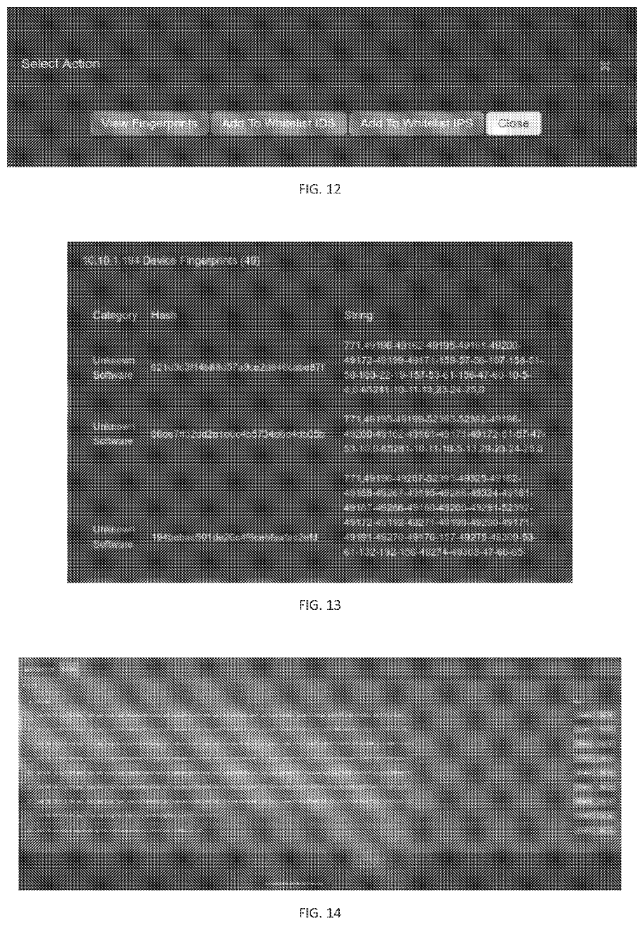

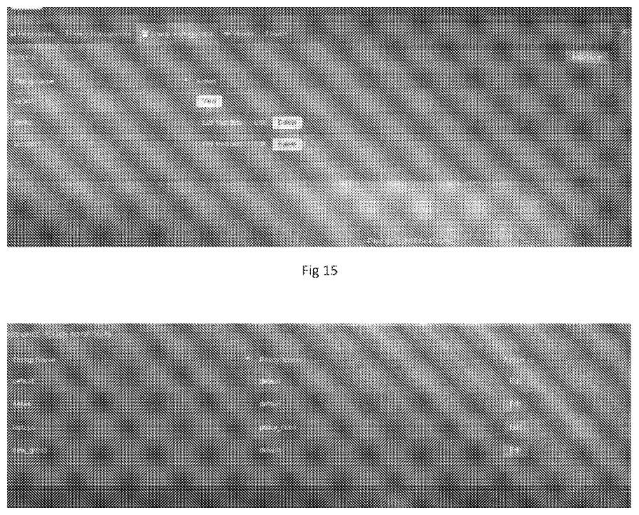

FIG. 3 shows a more complex implementation of the portion 14 of the process for conducting the comparison 60′. In this embodiment the library 58 comprises a whitelist 82, and a list of known software applications that are not permitted to access the not permitted services 54, herein referred to as a blacklist. In an embodiment the library 58 also comprises a list of unknown software applications that are or have tried to access the unknown services 52, hereafter referred to as a greylist.

In this embodiment the hash 56 is computed from the selected data 52 as before. Then the comparison to the lists in the library 58 are performed, which include determining whether the hash is on the blacklist 80 (‘y’ branch to comparison 70), in which case the data packet is dropped 68, such as by instructing the firewall of the gateway 20 to drop or block the packet. In this embodiment the ‘n’ branch of the comparison 70 then proceeds to comparison 72. The comparison 60′ also comprises determining whether the hash 56 is on the whitelist 82 (‘y’ branch to comparison 72), in which case the gateway 20 is allowed 64 to transmit the data packet to the Internet 15 and then on to the known permitted service 50. In the event that the hash 56 is not on the whitelist 82 (‘n’ branch to comparison 72) then the data packet is dropped 66, such as by instructing the firewall of the gateway 20 to drop or block the packet.

In an embodiment the hash 56 not on the whitelist (and not on the blacklist) is placed in the greylist 84. In an embodiment, inclusion on the greylist 84 allows a system administrator to investigate 90 the software application that created the TLS handshake data packet 46 and/or the unknown service 52. Entry of a fingerprint into the greylist 84 can create an alert for the system administrator to investigate. Upon conclusion of the investigation, the fingerprint is placed on one of the blacklist 80 or the whitelist 82, so that further comparisons result in allowing the TLS handshake data packet 46 when it is from a whitelisted software application.

It is becoming increasingly common for organisations to have a ‘bring your own device’ environment. In one environment (eg. home) the device may be permitted to use certain software applications (eg. a game or a social media application) which assess certain services. However, in another environment (eg. work) these same application may not be permitted to access the same services. In another case a user's laptop may be permitted to use certain applications and access certain online services that are different to the same user's smartphone. It is not desired to blacklist the device, nor is it always desirable to install local security applications on the user's devices (particularly their personal devices). An embodiment of the present invention can implement different policies for different machines having different applications.

FIG. 4 shows a further variation of the implementation of the portion 16 of the process for conducting the comparison 60″. In this embodiment the library 40 further comprises a set of rules for each device 32, 34, 36. The TCP packet will typically be the in form of a TCP/IP packet 96 and which will comprise the source device's network address (source IP address 98), which can be extracted from the TCP/IP packet 96. This can be included in a more complex form of compare 60″, where the whitelist (and/or blacklist, if applicable) can be different between different devices 32, 34, 36, according to the device rules 100. For example, device 32 might be allowed use a known social media service, but device 34, might not be allowed to use the same known social media service because of an organization policy defined in the rules 100. The rules 100 in effect result in the whitelist for device 32 including the known social media service, but the blacklist for device 34 would include the known social media service. The policy will be implemented within the local network (ie. the LAN 24, which may be for example a work organisation) but not on another local network (eg. the user's home network).

Further a profile 102 of behaviour can be recorded from the comparisons and in some embodiments from the outcome of the comparison for each device and/or for each software application (known or unknown) and/or for each service requested (known permitted service 50, known not permitted service 54 or unknown service 52). The profile 102 can be used for example in the investigation 90, or for other purposes, such as behaviour based intrusion detection.

In order to create the whitelist, an embodiment employs the following method: receiving a transport layer security handshake data packet sent over a computer network from a known software application running on a client device; extracting data from the packet (preferably those listed in 52); producing a fingerprint of the extracted data (preferably using hash MD5), wherein the fingerprint uniquely identifies the known software application; storing the fingerprint in a relationship with an identifier of the known software application (preferably in the whitelist of the library 40); storing an indication of whether each known software application is an authorised software application for the client device and/or is an authorised software application for the computer network (preferably in the rules storage 100).

A known software application might have different data in the selected data 50 of the handshake data 48 between different instances of the software application. For example, a new cypher may be implemented and the software application may request the new cypher in the Client Hello message compared to a previous instance of the same software application. There may be other reasons why the same software application may have a different hash, however this is expected to either change infrequently, or change between a set of repeatable hashes. In these cases, the known software application may have a one to many relationship with fingerprints, that is, two or more unique fingerprints may identify the one known software application. As these become known, they can be added to the whitelist of permitted applications (or is they are to be denied to the blacklist).

In such a manner a baseline of allowed applications for each device can be set on a local network 24. Thereafter if a computed fingerprint not on whitelist 82, the packet 44 will be blocked, in the manner described above.

Referring to FIG. 5, there is shown an embodiment of the IDS/IPS 22, 22′ which comprises a network interface 200 for receiving input from and providing output to the rest of the LAN 24; a processor 202 operatively interfaced with the network interface 200, a working memory 204 and a non-volatile storage 206. The processor 202 is configured to execute instructions stored in the storage 206, where the instructions configure the processor 202 to operate as the IDS/IPS, including as described herein, as the instructions are executed. The IDS/IPS 22, 22′ may comprise a known product, with adaption of its standard instructions (which may be firmware or software, and may include an operating system) to include instructions that configure it to operate according to the present invention. Thus, when the instructions are adapted as required, the IDS/IPS 22, 22′ is adapted to be an intrusion detection system according to this invention.

### EXAMPLE

A Client Hello TLS packet has the following fields extracted:

SSLVersion,Cipher,SSLExtension,EllipticCurve,EllipticCurvePointFormat

This data, being comma delimited, for example comprises:

769,47-53-5-10-49161-49162-49171-49172-50-56-19-4,0-10-11,23-24-25,0

If there are no SSL Extensions in the Client Hello, the fields are left empty.

For example:

769,4-5-10-9-100-98-3-6-19-18-99,,,

These strings are then MD5 hashed to produce an easily consumable and sharable 32 character fingerprint. This is the SSL Client Fingerprint.

769,47-53-5-10-49161-49162-49171-49172-50-56-19-4,0-10-11,23-24-25,0 -->
ada70206e40642a3e4461f35503241d5
769,4-5-10-9-100-98-3-6-19-18-99,,, --> de350869b8c85de67a350c8d186f11e6

The IDS has a fingerprint integration used to fingerprint TLS clients, called JA3, which is available from https://github.com/salesforce/ja3. JA3 is enabled in the IDS (set ‘app-layer.protocols.tls.ja3-fingerprints’ to ‘yes’).

A match on fingerprint is checked for.

Example:

```
alert tls any any −> any any (msg:“match JA3 string”; \
  ja3_string; content:“19-20-21-22”; \
  sid:100002;)
ja3_string is a ‘Sticky buffer’.
ja3_string can be used as fast_pattern.
```

A match on hash (md5) is checked for. Example:

```
alert tls any any −> any any (msg:“match JA3 hash”; \
  ja3_hash; content:“e7eca2baf4458d095b7f45da28c16c34”; \
  sid:100001;)
ja3_hash is a ‘Sticky buffer’.
ja3_string can be used as fast_pattern.
```

The Elastic Stack enables the IDS/IPS to reliably and securely take data from any source in any format and search, analyze, and visualize it in real time. Elastic Stack is described at: https://www.elastic.co/products

Elasticsearch is used as a universal storage for the IDS/IPS output. It stores detailed information about all network packages. Elastic can be asked to get exact information about items which are interesting.

A request can be made about TLS packets, for example:

```
GET /_search?pretty {
“query”: {
  “match”: {
    “event_type”: “tls”
  }
}
}
```

The response example looks like:

{
“took”: 4,
“timed_out”: false,
“_shards”: {
“total”: 16,
“successful”: 16,
“skipped”: 0,
“failed”: 0
},
“hits”: {
“total”: 758,
“max_score”: 3.0513022,
“hits”: [ {
“_index”: “report_index-2018.04.11”,
“_type”: “doc”,
“_id”: “AWKzE5RPEINjbyNsnXy7”,
“_score”: 3.0513022,
“_source”: {
“@timestamp”: “2018-04-11T05:00:24.947Z”,
“beat”: {
“hostname”: “localhost.localdomain”,
“name”: “localhost.localdomain”,
“version”: “5.6.6”
},
“dest_ip”: “185.60.216.19”,
“dest_port”: 443,
“event_type”: “tls”,
“flow_id”: 315300367630091,
“in_iface”: “eno1”,
“input_type”: “log”,
“offset”: 66595,
“proto”: “TCP”,
“source”: “/usr/local/var/log/suricata/eve.json”,
“src_ip”: “192.168.100.144”,
“src_port”: 44066,
“timestamp”: “2018-04-11T08:00:24.841639+0300”,
“tls”: {
“fingerprint”: “bd:25:8c:1f:62:a4:a6:d9:cf:7d:98:12:d2:2e:2f:f5:7e:84:fb:36”,
“issuerdn”: “C=US, O=DigiCert Inc, OU=www.digicert.com, CN=DigiCert SHA2
High Assurance Server CA”,
“ja3”: {
“hash”: “043a5d2d936910298e36e34acd8da818”,
“string”: “771,49196-49162-49195-52393-49161-49200-49172-49199-52392-
49171-57-51-53-47-10,0-23-65281-10-11-35-16-5-13,29-23-24-25,0”
},
“notafter”: “2019-03-22T12:00:00”,
“notbefore”: “2017-12-15T00:00:00”,
“serial”: “0B:3C:3B:60:1A:18:F5:9E:E2:B6:BB:05:60:5E:F2:C0”,
“sni”: “static.xx.fbcdn.net”,
“subject”: “C=US, ST=California, L=Menlo Park, O=Facebook, Inc.,
CN=*.facebook.com”,
“version”: “TLS 1.2”
},
“type”: “log”
}
},

Referring to FIG. 6, there is a screenshot of a listing of extracted information and a fingerprint of a transport layer security message according to an embodiment of the process of FIG. 2 as could be displayed by a terminal connected to the IDS/IPS 22. Shown is:

“dest_ip”, which is the destination IP address (IP address of the service 50, 52 or 54) of the Client Hello TLS packet;

“src_ip”, which is the source device IP address (IP address of the device 26, 28 or 30) of the Client Hello TLS packet;

“event type”, which indicates that the Client Hello TLS packet has been analysed or computer the “hash” (fingerprint).

In order to reduce memory usage whitelisting an application can use requests like:

```
GET
/_search?pretty&filter_path=took,hits.total,hits.hits._source.dest_ip,hits.hits._s
ource.dest_port,hits.hits._source.src_ip,hits.hits._source.proto,hits.hits._sourc
e.flow_id,hits.hits._source.in_iface,hits.hits._source.event_type,hits.hits._sour
ce.src_port,hits.hits._source.@timestamp,hits.hits._source.alert.category,hits.
hits._source.alert.signature_id,hits.hits._source.alert.severity,hits.hits._source.
alert.action,hits.hits._source.alert.action,hits.hits._source.alert.signature,hits.h
its._source.geoip.country_name
{
“size”:10000,
“query”: {
  “match”: {
    “event_type”: “alert”
  }
}
}
```

or

```
GET
/_search?pretty&filter_path=took,hits.total,hits.hits._source.dest_ip,hits.hits._s
ource.src_ip,hits.hits._source.tls.fingerprint,hits.hits._source.tls.ja3
{
  “size”:10000,
  “query”: {
    “match”: {
      “event_type”: “alert”
    }
  }
}
```

Also application may use queries with templates like:

```
POST /_search?pretty
{
“size”:10,
“query”: {
  “range” : {
    “@timestamp” : {
      “gte” : “now-50h/h”,
      “lte” : “now/d”
    }
  }
}
}
POST /_search?pretty
{
“size”: 12,
“query”: {
  “bool”: {
    “must”: { “match”: { “event_type”: “tls” }},
    “filter”: {
      “range”: { “@timestamp”: { “gte”: “now-48h/h” }}
    }
  }
}
}
```

An IDS/IPS is not known to have such whitelisting properties and there is no list of “good” “allowed” fingerprints.

To implement an example of the present invention a computer program is created which analyze TLS traffic and list of all known fingerprints.

An example of content of the file of known fingerprints looks like:

{“#”:1,“Ja3_hash”:“93948924e733e9df15a3bb44404cd909”,“category”:“Other
Software”,“desc”:“Adium 1.5.10 (a)”}
{“#”:2,“Ja3_hash”:“e4adf57bf4a7a2dc08e9495f1b05c0ea”,“category”:“Other
Software”,“desc”:“Adium 1.5.10 (b)”}
{“#”:3,“Ja3_hash”:“d5169d6e19447685bf6f1af8c055d94d”,“category”:“Android”,“desc
”:“AirCanada Android App”}
{“#”:4,“Ja3_hash”:“0bb402a703d08a608bf82763b1b63313”,“category”:“Android”,“de
sc”:“AirCanada Android App”}
{“#”:5,“Ja3_hash”:“662fdc668dd6af994a0f903dbcf25d66”,“category”:“Android”,“desc”
:“Android App”}
{“#”:6,“Ja3_hash”:“515601c4141e718865697050a7a1765f”,“category”:“Android”,“des
c”:“Android Google API Access”}
{“#”:7,“Ja3_hash”:“855953256ecc8e2b6d2360aff8e5d337”,“category”:“Android”,“des
c”:“Android Webkit Thing”}
{“#”:8,“Ja3_hash”:“99d8afeec9a4422120336ad720a5d692”,“category”:“Android”,“des
c”:“Android Webkit Thing”}
{“#”:9,“Ja3_hash”:“85bb8aa8e5ba373906348831bdbed41a”,“category”:“Android”,“de
sc”:“Android Webkit Thing”}
{“#”:10,“Ja3_hash”:“1aab4c2c84b6979c707ed052f724734b”,“category”:“Android”,“de
sc”:“Android Webkit Thing”}
{“#”:11,“Ja3_hash”:“5331a12866e19199b363f6e903381498”,“category”:“Android”,“de
sc”:“Android Webkit Thing”}
{“#”:12,“Ja3_hash”:“25b72c88f837567856118febcca761e0”,“category”:“Android”,“de
sc”:“Android Webkit Thing”}
{“#”:13,“Ja3_hash”:“d4693422c5ce1565377aca25940ad80c”,“category”:“Apple”,“des
c”:“Apple Push Notification System, Apple.WebKit.Net”}
{“#”:14,“Ja3_hash”:“3e404f1e1b5a79e614d7543a79f3a1da”,“category”:“Apple”,“desc
”:“Apple Spotlight Search (OSX)”}
{“#”:15,“Ja3_hash”:“69b2859aec70e8934229873fe53902fd”,“category”:“Apple”,“desc
”:“Apple Spotlight”}

Fingerprints can be categorized for example as:

2, Amazon Multimedia, Amazon Multimedia Software

3, Android, Android apps

4, Apple, Apple Apps

5, apple, apple apps

6, Atlassian, Atlassian software

7, Battle.net, Games Net

8, BlackBerry, BlackBerry Apps

9, Chrome, Crome Web browser

10, Chromium, Web browser

11, Cisco, Cisco Apps

12, Curl, curl

13, Eclipse, Eclipse Java

14, Debian_APT, Debian apt

15, Dropbox, Dropbox

16, Facebook,Facebook

17, Firefox,Firefox

18, GMail, Gmail SMTP Relay

19, GNU_Wget, Gnu wget 1.16.1built on darwin14.0.0

20, Git-Bash, Git (Tested v2.6.0)/curl 7.47.1 (cygwin)

On this base jparser tools create a set of rules—pass rule for whitelisted fingerprints and drop-alert rules otherwise (for blacklisted malware and unknown). This is very different to usual whitelisting.

New utilities can be provided for whitelisting.

1. janalyser—tool for TLS traffic analysis

This collects records about TLS packages from elasticsearch, filters and sorts them. It outputs 3 files:

devices.txt, devices_ip.txt and white_list_connection.txt.

device.txt has format—network interface; ip; name and for example looks like:

enp0s26u1u2; 10.10.1.45; crystaleye
enp0s26u2u2; 10.10.1.68;gateway
Unknown; 10.10.1.73;Device 2
eth4;10.10.1.77;Device 3
Unknown; 10.10.1.88;Device 4
Unknown; 192.168.100.151;Device 5

File devices_ip.txt is simply list of devices IPs:

10.10.1.45
10.10.1.68
10.10.1.73
10.10.1.77
10.10.1.88

white_list_connection.txt has more detailed and complex format and can be used as a tls report:

src_ip −> 192.168.100.151 ; dest_ip −> 103.70.234.12 ; hash −>
021d3c3f14b88d57a9ce2d946cabe87f ; def −> Android
src_ip −> 192.168.100.151 ; dest_ip −> 104.24.115.11 ; hash −>
021d3c3f14b88d57a9ce2d946cabe87f ; def −> Firefox plugin
src_ip −> 192.168.100.151 ; dest_ip −> 107.189.62.3 ; hash −>
021d3c3f14b88d57a9ce2d946cabe87f ; def −> Firefox
src_ip −> 10.10.1.68 ; dest_ip −> 104.210.208.34 ; hash −>
0318a5772c6150cfc9a3315d0b04f947 ; def −> Chrome group
src_ip −> 192.168.100.151 ; dest_ip −> 104.210.208.34 ; hash −>
0318a5772c6150cfc9a3315d0b04f947 ; def −> Unknown Software
src_ip −> 10.10.1.68 ; dest_ip −> 104.81.208.32 ; hash −>
0318a5772c6150cfc9a3315d0b04f947 ; def −> Unknown Software
src_ip −> 192.168.100.151 ; dest_ip −> 104.81.208.32 ; hash −>
0318a5772c6150cfc9a3315d0b04f947 ; def −> Unknown Software
src_ip −> 10.10.1.68 ; dest_ip −> 104.81.222.83 ; hash −>
0318a5772c6150cfc9a3315d0b04f947 ; def −> Unknown Software
src_ip −> 192.168.100.151 ; dest_ip −> 104.81.222.83 ; hash −>
0318a5772c6150cfc9a3315d0b04f947 ; def −> Unknown Software
src_ip −> 10.10.1.68 ; dest_ip −> 104.81.226.67 ; hash −>
0318a5772c6150cfc9a3315d0b04f947 ; def −> Unknown Software
src_ip −> 192.168.100.151 ; dest_ip −> 104.81.226.67 ; hash −>
0318a5772c6150cfc9a3315d0b04f947 ; def −> Unknown Software
src_ip −> 10.10.1.68 ; dest_ip −> 13.107.21.200 ; hash −>
0318a5772c6150cfc9a3315d0b04f947 ; def −> Unknown Software
src_ip −> 192.168.100.151 ; dest_ip −> 13.107.21.200 ; hash −>
0318a5772c6150cfc9a3315d0b04f947 ; def −> Unknown Software

Usage: janalyser path_to_output_files

All tools use /var/lib/jparser folder for output.

2. jmapper

This tool can collect data from net mapping application and produces 2 files on output:

devices.txt, devices_ip.txt.

Files have same format as janalyser files, but contain data only about devices behind the IDS.

3. jreport

Usage: jreport path_to_output_files

This program uses data collected by janalyser and generates json output file—white_list_report.json.

4. jrules

This program generates rules for each device.

Usage: jrules /folder_with_input_info /output_folder a|d device1_ip device2_ip ....
devicen_ip

a|d—you must select option—a—for alerts, d for drops

For example:

alert tls 10.10.1.68 any −> any any (msg:“alert match whitelisting hash malware or
unknown hash Unknown Software”; ja3_hash;
content:“0318a5772c6150cfc9a3315d0b04f947”; sid:1100000;rev:11;)
alert tls 10.10.1.68 any −> any any (msg:“alert match whitelisting hash malware or
unknown hash Unknown Software”; ja3_hash;
content:“0e2086e1f005e8872c97d9a3c2e56af3”; sid:1100001;rev:11;)
alert tls 10.10.1.68 any −> any any (msg:“alert match whitelisting hash malware or
unknown hash Unknown Software”; ja3_hash;
content:“13335b8c9503f9dc6ffad97551dc3cad”; sid:1100002;rev:11;)
alert tls 10.10.1.68 any −> any any (msg:“alert match whitelisting hash malware or
unknown hash Unknown Software”; ja3_hash;
content:“162b4f1e21c7d5a37204e5884f4873a1”; sid:1100003;rev:11;)
alert tls 10.10.1.68 any −> any any (msg:“alert match whitelisting hash malware or
unknown hash Unknown Software”; ja3_hash;
content:“2e3489bae31cd3e32f38d5293e983c49”; sid:1100004;rev:11;)
alert tls 10.10.1.68 any −> any any (msg:“alert match whitelisting hash malware or
unknown hash Unknown Software”; ja3_hash;
content:“48216eb48d8fb7124ce9f1946263597e”; sid:1100005;rev:11;)
alert tls 10.10.1.68 any −> any any (msg:“alert match whitelisting hash malware or
unknown hash Unknown Software”; ja3_hash;
content:“6da03a291c07db5bb31d043bb53c4e59”; sid:1100006;rev:11;)
alert tls 10.10.1.68 any −> any any (msg:“alert match whitelisting hash malware or
unknown hash Unknown Software”; ja3_hash;
content:“737bd1f00ac3e08ead0eee1dc7e1144d”; sid:1100007;rev:11;)
alert tls 10.10.1.68 any −> any any (msg:“alert match whitelisting hash malware or
unknown hash Unknown Software”; ja3_hash;
content:“765f7fb49e4a4275fee02c23b92e61c4”; sid:1100008;rev:11;)
alert tls 10.10.1.68 any −> any any (msg:“alert match whitelisting hash malware or
unknown hash Unknown Software”; ja3_hash;
content:“80db4b83c6775c3635854e24006681a9”; sid:1100009;rev:11;)
alert tls 10.10.1.68 any −> any any (msg:“alert match whitelisting hash malware or
unknown hash Unknown Software”; ja3_hash;
content:“b6996d6eecf38d22cfca9590f94297b0”; sid:1100010;rev:11;)
alert tls 10.10.1.68 any −> any any (msg:“alert match whitelisting hash malware or
unknown hash Unknown Software”; ja3_hash;
content:“c06296f6ac29d4ca014a56312534ba8d”; sid:1100011;rev:11;)
alert tls 10.10.1.68 any −> any any (msg:“alert match whitelisting hash malware or
unknown hash Unknown Software”; ja3_hash;
content:“d8e77cc783b249de6e348525176cdfa3”; sid:1100012;rev:11;)
alert tls 10.10.1.68 any −> any any (msg:“alert match whitelisting hash malware or
unknown hash Unknown Software”; ja3_hash;
content:“d9bcc0b05a1e67c11abc85bf5ca55c90”; sid:1100013;rev:11;)
alert tls 10.10.1.68 any −> any any (msg:“alert match whitelisting hash malware or
unknown hash Unknown Software”; ja3_hash;
content:“e3d9d8f7b3d9f626d0696a76b4c4501f”; sid:1100014;rev:11;)
alert tls 10.10.1.68 any −> any any (msg:“not match any whitelisting hash”;
sid:1100015;rev:11;)
alert tls any any −> any any (msg:“not match any whitelisting hash”;
sid:1100015;rev:11;)
reject tls 10.10.1.68 any −> any any (msg:“reject match whitelisting hash malware or
unknown hash Unknown Software”; ja3_hash;
content:“0318a5772c6150cfc9a3315d0b04f947”; sid:1100000;rev:11;)
reject tls 10.10.1.68 any −> any any (msg:“reject match whitelisting hash malware or
unknown hash Unknown Software”; ja3_hash;
content:“0e2086e1f005e8872c97d9a3c2e56af3”; sid:1100001;rev:11;)
reject tls 10.10.1.68 any −> any any (msg:“reject match whitelisting hash malware or
unknown hash Unknown Software”; ja3_hash;
content:“13335b8c9503f9dc6ffad97551dc3cad”; sid:1100002;rev:11;)
reject tls 10.10.1.68 any −> any any (msg:“reject match whitelisting hash malware or
unknown hash Unknown Software”; ja3_hash;
content:“162b4f1e21c7d5a37204e5884f4873a1”; sid:1100003;rev:11;)
reject tls 10.10.1.68 any −> any any (msg:“reject match whitelisting hash malware or
unknown hash Unknown Software”; ja3_hash;
content:“2e3489bae31cd3e32f38d5293e983c49”; sid:1100004;rev:11;)
reject tls 10.10.1.68 any −> any any (msg:“reject match whitelisting hash malware or
unknown hash Unknown Software”; ja3_hash;
content:“48216eb48d8fb7124ce9f1946263597e”; sid:1100005;rev:11;)
reject tls 10.10.1.68 any −> any any (msg:“reject match whitelisting hash malware or
unknown hash Unknown Software”; ja3_hash;
content:“6da03a291c07db5bb31d043bb53c4e59”; sid:1100006;rev:11;)
reject tls 10.10.1.68 any −> any any (msg:“reject match whitelisting hash malware or
unknown hash Unknown Software”; ja3_hash;
content:“737bd1f00ac3e08ead0eee1dc7e1144d”; sid:1100007;rev:11;)
reject tls 10.10.1.68 any −> any any (msg:“reject match whitelisting hash malware or
unknown hash Unknown Software”; ja3_hash;
content:“765f7fb49e4a4275fee02c23b92e61c4”; sid:1100008;rev:11;)
reject tls 10.10.1.68 any −> any any (msg:“reject match whitelisting hash malware or
unknown hash Unknown Software”; ja3_hash;
content:“80db4b83c6775c3635854e24006681a9”; sid:1100009;rev:11;)
reject tls 10.10.1.68 any −> any any (msg:“reject match whitelisting hash malware or
unknown hash Unknown Software”; ja3_hash;
content:“b6996d6eecf38d22cfca9590f94297b0”; sid:1100010;rev:11;)
reject tls 10.10.1.68 any −> any any (msg:“reject match whitelisting hash malware or
unknown hash Unknown Software”; ja3_hash;
content:“c06296f6ac29d4ca014a56312534ba8d”; sid:1100011;rev:11;)
reject tls 10.10.1.68 any −> any any (msg:“reject match whitelisting hash malware or
unknown hash Unknown Software”; ja3_hash;
content:“d8e77cc783b249de6e348525176cdfa3”; sid:1100012;rev:11;)
reject tls 10.10.1.68 any −> any any (msg:“reject match whitelisting hash malware or
unknown hash Unknown Software”; ja3_hash;
content:“d9bcc0b05a1e67c11abc85bf5ca55c90”; sid:1100013;rev:11;)
reject tls 10.10.1.68 any −> any any (msg:“reject match whitelisting hash malware or
unknown hash Unknown Software”; ja3_hash;
content:“e3d9d8f7b3d9f626d0696a76b4c4501f”; sid:1100014;rev:11;)
reject tls 10.10.1.68 any −> any any (msg:“not match any whitelisting hash”;
sid:1100015;rev:11;)
reject tls any any −> any any (msg:“not match any whitelisting hash”;
sid:1100015;rev:11;)

5. jrules_files

This program generates rules for devices listed in file.

Usage: jrules_file/folder_with_input_info/output_folder a|d file_with_devices_list

### 6. Jgenerator

This program generates rules for groups of devices and polices. It generates awl.yaml file, which must be included in suricata.yaml. Awl.yaml looks like:

DESKS: “[10.10.1.232,10.10.1.155]”

DEFAULT: “[10.10.1.149]”

GROUP1: “[10.10.1.179, 10.10.1.188]”

and it also generates rules, looking like:

allow tls [$LAPTOPS,$DESKS] any −> any any (msg:“allow match whitelisting
known hash Apple”; ja3_hash;
content:“e4d448cdfe06dc1243c1eb026c74ac9a”; sid:1102319;rev:11;)
allow tls [$LAPTOPS,$DESKS] any −> any any (msg:“allow match whitelisting
known hash Apple”; ja3_hash; content:“f1c5cf087b959cec31bd6285407f689a”;
sid:1102320;rev:11;)
allow tls [$LAPTOPS,$DESKS] any −> any any (msg:“allow match whitelisting
known hash Other Software”; ja3_hash;
content:“f28d34ce9e732f644de2350027d74c3f”; sid:1102321;rev:11;)
allow tls [$LAPTOPS,$DESKS] any −> any any(msg:“allow match whitelisting
known hash Dropbox”; ja3_hash;
content:“190dfb280fe3b541acc6a2e5f00690e6”; sid:1102322;rev:11;)
allow tls [$LAPTOPS,$DESKS] any −> any any (msg:“allow match whitelisting
known hash Chrome”; ja3_hash;
content:“20dd18bdd3209ea718989030a6f93364”; sid:1102323;rev:11;)
allow tls [$DEFAULT] any −> any any (msg:“allow match whitelisting known
hash Viber”; ja3_hash; content:“e0224fc1c33658f2d3d963bfb0a76a85”;
sid:1102324;rev:11;)
allow tls [$LAPTOPS,$DESKS] any −> any any (msg:“allowmatch whitelisting
known hash Other Software”; ja3_hash;
content:“01319090aea981dde6fc8d6ae71ead54”; sid:1102325;rev:11;)
allow tls [$LAPTOPS,$DESKS] any −> any any (msg:“allow match whitelisting
known hash Other Software”; ja3_hash;
content:“84607748f3887541dd60fe974a042c71”; sid:1102326;rev:11;)
allow tls [$LAPTOPS,$DESKS] any −> any any (msg:“allow match whitelisting
known hash Other Software”; ja3_hash;
content:“c2b4710c6888a5d47befe865c8e6fb19”; sid:1102327;rev:11;)

Usage: jgenerator/folder_with_rules

For groups a groups.json file can be used:

```
{
  “groups”: [
  {
  “name”:“default”,
  “policy”:“default”,
  “devices”:}
    {
    “name”:“one”,
    “ip” : “192.168.8.101”
    },
    {
    “name”:“two”,
    “ip” : “192.168.8.102”
    }
  ]
  },
  {
  “name”:“User defined”,
  “policy”:“custom”,
  “devices”:[
    {
    “name”:“three”,
    “ip” : “192.168.8.103”
    },
  {
  “name”:“fore”,
  “ip” : “192.168.8.104”
  }
  ]
  }
  ]
}
```

An example for policies:

```
{
  “policies”: [
    {
    “name”:“default”,
    “caterories”:[“firefox”,“chrome”,“thunderbird”]
    },
    {
    “name”:“custom”,
    “caterories”:[“firefox”,“chrome”,“thunderbird”,“eclipse”]
    }
  ]
}
```

7. stop_whitelisting

This is a script which deletes all whitelisting data.

#!/usr/bin/env bash
cat/dev/null > /var/lib/jparser/devices.txt
rm -f /var/lib/jparser/white_list_data.txt
rm -f /var/lib/jparser/white_list_connections. txt
rm -f /var/lib/jparser/white_list_report.json
rm -f /var/lib/jparser/devices_ip.txt
rm -f /etc/suricata/rules/white_list.rules

### Makefile and Build Procedure

Referring to FIG. 7 there is shown a flow diagram of a use of the example tools described above. The Elasticsearch provides results to Janalyser which produces files devices.txt, devices_ip.txt. white_list_connecton.txt for devices behind the IDS (CE). It also provides a network mapping to Jmapper. This produces files devices.txt, devices_ip.txt. white_list_connection.txt for all devices in the network. These files are used by Jreport to produce the file white_list_report.json which is provided the Jgenerator which can be used to produce rules.

Usual make file is used to build and install utilities. For example:

```
  #Makefile for compiling jtools
  CC = g++
  LD = g++
  INCDIR = -I./include
  CFLAGS = -g3 -Wall -c $(INCDIR) -std=c++11
  LDFLAG = -g3 -Wall -std=c++11
  LDLIB = -Ijsoncpp /usr/lib64/libcurl.so.4
  all: jparser jreport jrules jrules_file janalyzer jmapper jgenerator
jparser: main.o item.o rule_item.o
$(LD) $(LDFLAG) $\hat{ } -o $@ $(LDLIB)
jreport: jreport.o item.o rule_item.o device.o devices.o reportitem.o
$(LD) $(LDFLAG) $\hat{ } -o $@ $(LDLIB)
jrules : jrules.o item.o rule_item.o
$(LD) $(LDFLAG)$\hat{ } -o $@ $(LDLIB)
jrules_file : jrules_file.o item.o rule_item.o
$(LD) $(LDFLAG) $\hat{ } -o $@ $(LDLIB)
janalyzer: janalyzer.o item.o rule_item.o
$(LD) $(LDFLAG) $\hat{ } -o $@ $(LDUB)
jmapper: jmapper.o item.o rule_item.o device.o devices.o
$(LD) $(LDFLAG) $\hat{ } -o $@ $(LDLIB)
jgenerator: jgenerator.o group.o groups.o policy.o device.o devices.o policies.o
reportitem.o helper.o
$(LD) $(LDFLAG) $\hat{ } -o $@ $(LDLIB)
main.o: main.cpp
$(CC) $(CFLAGS) $<
jrules.o: jrules.cpp
$(CC) $(CFLAGS) $<
jrules_file.o: jrules_file.cpp
$(CC) $(CFLAGS) $<
jreport.o : jreport.cpp
$(CC) $(CFLAGS) $<
janalyzer.o : janalyzer.cpp
$(CC) $(CFLAGS) $<
jmapper.o: jmapper.cpp
$(CC) $(CFLAGS) $<
group.o : group.cpp ./include/group.h
$(CC) $(CFLAGS) $<
groups.o : groups.cpp ./include/groups.h
$(CC) $(CFLAGS) $<
policy.o :policy.cpp ./include/policy.h
$(CC) $(CFLAGS) $<
policies.o : policies.cpp ./include/policies.h
$(CC) $(CFLAGS) $<
device.o: device.cpp ./include/device.h
$(CC) $(CFLAGS) $<
devices.o: devices.cpp ./include/devices.h
$(CC) $(CFLAGS) $<
reportitem.o : reportitem.cpp ./include/reportitem.h
$(CC) $(CFLAGS) $<
rule_item.o: rule_item.cpp ./include/rule_item.h
$(CC) $(CFLAGS) $<
item.o : item.cpp ./include/item.h
$(CC) $(CFLAGS) $<
helper.o: helper.cpp ./include/helper.h
$(CC) $(CFLAGS) $<
jgenerator.o: jgenerator.cpp
$(CC) $(CFLAGS) $<
install: jparser jreport jrules jrules_file janalyzer jmapper jgenerator full.json
ja3fingerprint.json categories.txt categories_orig.txt
mkdir -p /etc/jparser
cp full.json /etc/jparser
cp ja3fingerprint.json /etc/jparser
cp categories.txt/etc/jparser
cp categories_orig.txt/etc/jparser
cp jparser /usr/bin
cp jrules /usr/bin
cp jreport /usr/bin
cp janalyzer /usr/bin
cp jmapper /usr/bin
cp jgenerator /usr/bin
clean : rm -f jrules jreport jparser janalyzer jrules_file jmapper jgenerator
jgenerator.o main.o item.o rule_item.o jrules.o jreport.o janalyzer.o reportitem.o
device.o devices.o jrules_file.o jmapper.o group.o groups.o policy.o policies.o
helper.o
-std=c++11 option is important.
-g3 should be removed in final version, it only inserts debugging information in exe file
```

### PHP code

All jparser tools are used in php code for gateway_whitelisting application. For example, like in fragment below:

```
public function make_report( )
{
  crystaleye_profiIe(_METHOD_,_LINE_);
  try{
    $shell = new Shell( );
    $d = “d”;
    $o = 0;
    $retval = $shell−>execute(“/usr/bin/jreport”, “/var/lib/jparser ” , true,‘log’);
    if ($retval === 0) {
      return true;
    } else {
      $output = false;
    }
    return $output;
  } catch (Engine_Exception $e) {
    return false;
  }
}
////////////
public function make_rules_drop( )
{
  crystaleye_profile(_METHOD_,_LINE_);
  try{
    $shell = new Shell( );
    $d = “d”;
    $o = 0;
    $retval = $shell−>execute(“/usr/bin/jrules_file”, “/var/lib/jparser
/etc/suricata/rules/ d /var/lib/jparser/devices_ip.txt”, true,‘log’);
    if ($retval === 0) {
      return true;
    } else {
      $output = false;
    }
    return $output;
  } catch (Engine_Exception $e) {
    return false;
  }
}
```

### Controlling Elastic For Number of Output Records

By default, elasticsearch returns only 10000 records (its parameter index.max_result is equal to 10000).

We can control elastic index.max_result_window is to use request, as follows:

PUT_all/_settings ?preserve_existing=true’ {
“index.max_result_window”: “300000”
}

We set large index.max to high values before request about TLS packages. And return it to default 10000 after TLS request is done.

jparser tools can control elasticsearch max records index.

FIG. 8 is a screenshot of a user interface of the IDS/IPS 22 showing a visual representation in the form of a map of devices on the LAN 24 has have been identified. The map of the local network devices can provide enhanced visibility of devices on the LAN 24 to a system administrator. Devices identified on the network can be allocated to a device type, and optionally can also be allocated a device nickname, as shown. Each device can then be allocated a content filter policy. In this example a device is selected on the map and then as shown in FIGS. 9 and 10 a policy can be selected, thereby allocating the device a content filter policy. An aspect of the allocated content filter policy may implement the present invention by including in the policy a whitelist of fingerprints of services that the selected device is permitted to access. Selection of the policy may also include a blacklist of fingerprints of services that the selected device is permitted to access. Thus, the present invention can be included in the user interface of allocation security or other content control available to a system administrator of a local network.

FIG. 11 is a screenshot of a user interface of the IDS/IPS 22 showing a map of devices labelled with their IP address on a network which have fingerprints that have been detected, may not have been assigned a policy on what to do when the device initiates a Client Hello TLS packet of a software application. In this example, devices without an allocated policy for a fingerprint is shown. Each device on the map can be selected and a user interface showing options available in relation to an identified software application can be opened as shown in FIG. 12. The fingerprints of the software applications that the device has had applications send Client Hello TLS packets can be listed. A fingerprint can be added to a whitelist of the IDS and/or the fingerprint can be added to the whitelist of the IPS.

FIG. 13 is a screenshot of a user interface showing example fingerprints of a device. Each of these fingerprints (hashes) are not identified as coming from a known software application running on the device. The string can assist the system operator in deciding whether the software application should be listed on the whitelist.

FIG. 14 is a screenshot of a user interface showing a listing of rules applied to fingerprints of network traffic from a device (in this example device having IP address 10.10.1.194).

In another example the invention can detect:

Chrome running on OSX (hash=94c485bca29d5392be53f2b8cf7f4304) or
the Dyre malware family running on Windows
(hash=b386946a5a44d1ddcc843bc75336dfce) or
Metasploit's Meterpreter running on Linux
(hash=5d65ea3fb1d4aa7d826733d2f2cbbb1d).

FIG. 15 is screenshot of a user interface showing a rule group manager. By allocating devices on the network to a group the policy or rule applied to the group can be applied to all of the devices in that group. Members of the group can be changes and the rules of each group can be changed.

FIG. 16 screenshot of a user interface showing the allocation of different policies to each group. For instance, desks (short for desktops) are a type of group and they are allocated the ‘default’ policy. Laptops are a type of group and they are allocated the ‘policy_main’ policy.

An example data structure is in the following tables:

Categories

| | |
|---|---|
| Category id | int |
| Category Name | string |

Fingerprints

| | |
|---|---|
| Fingerprint id | int |
| Hash | string |
| Category id (foreign key) | int |

Policies

| | |
|---|---|
| Policy name | string |
| Policy id | int |

PolicyCategories

| | |
|---|---|
| Policy id | int |
| Category id | int |

Devices

| | |
|---|---|
| Device name | string |
| Device id | int |

Groups

| | |
|---|---|
| Group name | string |
| Group id | int |
| Policy | Policy id |

DeviceGroups

| | |
|---|---|
| Device id | int |
| Group id | int |

The IDS/IPS gateway application whitelisting works at the network level, and allows the administrator to control those applications from communicating on the LAN.

In on embodiment the client devices are “Internet of Things” (IOT) devices, which are notoriously difficult exercise control over. The one or more IOT devices can be recognised, for example be being allocated an IP address, grouped into a category of device (IOT devices) and have policies applied which permit data traffic from a known (and expected) client application (ie the fingerprint for that application is whitelisted), such as a datalogging application running on the IOT device. However data traffic from that device (or devices in that group) that have a blacklisted finger print will be blocked. Further in the event of an unknown fingerprint entering the network, further investigation can be conducted. Thus hacking of an IOT device can be more readily detected.

This allows for simple and effective detection of client applications and malware families, regardless of their destination, Command and Control (C2) IPs, or SSL certificates.

The present invention provides an effective way to detect malicious activity over SSL that can be better than IP or domain based indicators of compromise. Since the fingerprinting can detect the client application, it doesn't matter if malware uses DGA (Domain Generation Algorithms), or different IPs for each C2 host, or even if the malware uses Twitter for C2. The fingerprinting can detect the malware itself based on how it communicates rather than what it communicates with.

TLS fingerprinting is also an excellent detection mechanism in locked-down environments where only a few specific applications are allowed to be installed. In these types of environment, a whitelist can be built of expected applications and then alert on any other communication.

Modifications may be made to the present invention within the context of that described and shown in the drawings. Such modifications are intended to form part of the invention described in this specification.

1. A method of permitting data traffic over a network, comprising:
receiving a transport layer security handshake data packet sent over a computer network from a software application running on a client device from within the computer network;
extracting data from the packet;
producing a fingerprint of the extracted data;
comparing the fingerprint to a whitelist library of fingerprints of authorised software applications so as to identify whether the fingerprint is in the whitelist library;
in the event that the fingerprint is in the whitelist library, permitting outgoing data traffic from the client over the network and/or outgoing data traffic from the client to a connected external network.

2. The method according to claim 1, further comprising, in the event that the fingerprint is not in the whitelist library, denying data traffic from the client over the network and/or to the connected external network.

3. The method according to claim 1, further comprising, comparing the fingerprint to a blacklist library of fingerprints of unauthorised software applications so as to identify whether the fingerprint is in the blacklist library; wherein in the event that the fingerprint is in the blacklist library dropping the data packet; wherein in the event that the fingerprint is not in the whitelist library or the blacklist library, then the method further comprises triggering further investigation of the software application.

4. The method according to claim 1, further comprising, determining whether the client device is permitted to use the software application on the network according to the identified fingerprint and in the event that the device is permitted to use the software application on the network allowing the handshake data packet to be transmitted over the network.

5. The method according to claim 1, further comprising, applying a rule or rule set to the fingerprint to determine an extent of permission the client has to send data traffic to the network.

6. The method according to claim 1, further comprising, sending the fingerprint from a sniffing device on the network to a remote service for comparing to the whitelist, and returning an indication as to whether the software application is on the whitelist from the remote service to the sniffing device.

7. The method according to claim 6, further comprising, permitting or denying of data traffic is performed by an intrusion security device on the network.

8. The method according to claim 7, wherein the indication as to whether the software application is on the whitelist is provided to the intrusion security device.

9. A method of permitting data traffic over a network, comprising:
receiving a transport layer security handshake data packet from a client over a network;
extracting data from the packet;
hashing the extracted data;
comparing the hashed data to a list of hashes of applications that are not authorised on the network.

10. The method of claim 9 further comprising disallowing the handshake data packet to be transmitted over the network in the event that the hashed data is on the list of hashes of applications that are not authorised on the network.

11. The method of claim 9 further comprising comparing the hashed data to a list of hashes of applications that are authorised on the network.

12. The method of claim 9 further comprising disallowing the handshake data packet to be transmitted over the network in the event that the hashed data is not on the list of hashes of applications that are authorised on the network.

13. A method of permitting data traffic over a network, comprising
receiving a transport layer security handshake data packet from a client over a network;
extracting data from the packet;
hashing the extracted data;
comparing the hashed data to a list of hashes of applications that are authorised on the network.

14. The method of claim 13 further comprising disallowing the handshake data packet to be transmitted over the network in the event that the hashed data is not on the list of hashes of applications that are authorised on the network.

15. The method of claim 9, wherein the list of hashes is determined according to the identity of the client.

16. A device for permitting data traffic over a network, comprising:
a network connection for receiving a transport layer security handshake data packet sent over a computer network from a software application running on a client device within the network;
a processor for extracting data from the received packet and producing a fingerprint of the extracted data;
a processor for comparing the fingerprint to a whitelist library of fingerprints of authorised software applications so as to identify whether the fingerprint is in the whitelist library;
an output for signalling data traffic from the client over the network is permitted in the event that the fingerprint is in the whitelist library.

17. The device according to claim 16, wherein the signalled data traffic permitted is the transport layer security handshake data packet or data traffic related to transport layer security handshake data packet.

18. The device according to claim 16, wherein the data traffic related to transport layer security handshake data packet is traffic directed to a network connected service having a destination address included in the extracted data.

19. The device according to claim 16, wherein the output is further configured to signal data traffic related to the software application is not permitted in the event that the fingerprint is not in the whitelist library.

20. The device according to claim 16, wherein the processor is configured to compare the whitelist library according to the identity of the client device.

21.-33.(canceled)

34. The method of claim 13, wherein the list of hashes is determined according to the identity of the client.
